(19) United States
(12) Patent Application Publication
(10) Pub. No.: US 2024/0220657 A1
(43) Pub. Date: Jul. 4, 2024

(54) A METHOD, A MONITORING SYSTEM AND A COMPUTER PROGRAM PRODUCT FOR MONITORING AND SECURING A NETWORK CONNECTED CONTROLLER

(71) Applicant: aXite Intelligence Services B.V., Baarn (NL)

(72) Inventors: Menno Folkert CADEE, Baarn (NL); Lambertus Theodorus WILLEMSEN, Baarn (NL); Tommy Petrus Maria JANSSEN, Baarn (NL)

(21) Appl. No.: 17/922,519

(22) PCT Filed: Jul. 14, 2022
(86) PCT No.: PCT/NL2022/050411

§ 371 Date: Oct. 31, 2022

(30) Foreign Application Priority Data
Jul. 15, 2021 (NL) 2028737

(51) Int. Cl. G06F 21/64; G06F 21/55; G06F 21/60

(52) U.S. Cl. CPC G06F 21/64; G06F 21/552; G06F 21/606

(57) ABSTRACT

The invention relates to a method for monitoring and securing a network connected controller. The method includes a step of providing a data acquisition device interconnected between the controller and the network. Further, the method includes a step of extracting data from the controller, using the data acquisition device. The invention also relates to a data acquisition device.

The invention relates to a method for monitoring and securing a network connected controller.

Network connected controllers, such as PLC's, are widely used for various (industrial) applications including high critical infrastructural systems. Sometimes these controllers suffer from a technical malfunction, which can lead to considerable downtime of a facility, and thus to a possible large financial loss. In order to solve or prevent such a technical malfunction possible errors in the network and/or PLC's can be localized. The diagnosis may be performed by people trained in finding error profiles. However, this approach has several disadvantages. For example, the diagnosis is subjective as it is dependent on the experience of this particular individual or the diagnosis may be too late for timely restoration/recovery of the process running on the controller or the person himself made an unintended mistake causing (financial) damage. Also unauthorized or authorized persons can make intended or unintended modifications to the PLC and/or network to interrupt the process.

In addition, an unauthorized person or entity can cause disruptive network activity that results in interrupted operations (denial of service) or they can modify the configuration of the controller to add malicious functionality that molests or interrupts operations.

Cybersecurity in the industrial control systems, ICS, and supervisory control and data acquisition, SCADA, is a developing field. There is an on-going effort to reduce the cybersecurity risks and to improve the cyber resilience. Security through the lack of external connectivity, the “air gap”, is disappearing as more and more devices and sensors are being connected to the internet or even Open Architecture to share data. Furthermore, air-gapped trusted local networks are still susceptible to supply chain attacks, phishing operations and insider threats, to name a few.

Older operational equipment (Legacy assets), become “vendor unsupported” and are very vulnerable for cyber attacks. In the meantime, hackers are getting closer to the bare metal of a computer and their access is getting deeper and more resilient.

The cybersecurity industry developed measures to protect vulnerable systems by establishing digital as well as physical based perimeters around them, with firewalls and antivirus software. However, vulnerability is still a non-trivial issue.

An object of the invention is to overcome at least some of the above disadvantages associated with monitoring a network connected controller. Thereto, the invention provides a method for monitoring and securing a network connected controller, comprising the steps of providing a data acquisition device interconnected between the controller and the network, and extracting data from the controller, using the data acquisition device.

By providing a data acquisition device interconnected between the controller and the network, an inline and robust monitoring process may be realized, enabling a monitoring process of data communication, e.g. for detection and/or protection against intrusion of malware and/or malicious data communication. The data acquisition device may be interconnected between the controller and a network switch interfacing between the controller and the network so as to realize an end-point protection at low, machine, level, enabling the usage of in-dept defense capabilities and the possibility to intervene.

By implementing the data acquisition device inline between the controller and the network, an inherent secure process may be performed, rendering, in principle, any adaptions to the network and/or controller superfluous. As an example, the controller may operate without software modifications. The process can be non-intrusive and/or independent on technology, protocol and/or supplier of the network and/or the controller.

Preferably, the step of extracting data is performed during operation of the controller. Then, the controller can be monitored e.g. while performing under approved and/or normal conditions, thereby minimizing any undesired interruption with the data acquisition device and providing real time performance.

Advantageously, the data acquisition device enables operational data exchange between the controller and the network, thus minimizing any undesired interruption between the controller and the network.

The monitoring system having the advantageous features of transparency and real time performance can advantageously be used for monitoring and protecting highly critical infrastructural assets such as public service utilities and airport subsystems.

In an embodiment, the extracted data is processed, e.g. including decrypting, decompiling and/or comparing the extracted data with pre-specified data such as program blocks, thus enabling a verification process for integrity purposes of an operating program running on the controller. Optionally, artificial intelligence, a neural network, a rule based system or any data learned system may be used for recognizing normal or non-deviating data in the extracted data so as to enable detection of deviating data in a monitoring process.

Highly preferably, the data acquisition device is also arranged for performing a step of controlling a process running on the controller and/or ensuring configuration integrity, e.g. by intervening or interrupting said process, or initiating another process on the controller. Then, a so-called change control process may be implemented. As an example, various data types can be restored to the controller, including control data and/or a program. Then, the device serves as an interplay device, both collecting data and controlling operation of the controller. The data acquisition device may then be arranged for two-way communication, including e.g. a step of extracting data from the controller process as well as a step of controlling a process running on the controller and/or verifying and/or ensuring integrity of the controller configuration.

The network can be any data network, e.g. an industrial ethernet protocol type network, such as PROFINET, Ethernet/IP and OPC.

According to another aspect of the invention, a monitoring system for monitoring and securing a network connected controller is provided, wherein the system comprises a data acquisition device interconnectable between the controller and the network, wherein the data acquisition device is arranged for extracting data from the controller.

Further, the invention relates to a computer program product for monitoring and securing a network connected controller. A computer program product may comprise a set of computer executable instructions stored on a data carrier, such as but not limited to a flash memory, a CD or a DVD. The set of computer executable instructions, which allow a programmable computer to carry out the method as defined above, may also be available for downloading from a remote server, for example via the Internet.

The computer program product comprises computer readable code for causing a data acquisition device interconnected between the controller and the network to perform the step of extracting data from the controller. Other advantageous embodiments according to the inventions are described in the following claims.

It should be noted that the technical features described above or below may each on its own be embodied in a monitoring method or monitoring system, i.e. isolated from the context in which it is described, separate from other features, or in combination with only a number of the other features described in the context in which it is disclosed. Each of these features may further be combined with any other feature disclosed, in any combination.

The invention will now be further elucidated on the basis of a number of exemplary embodiments and an accompanying drawing. In the drawing:

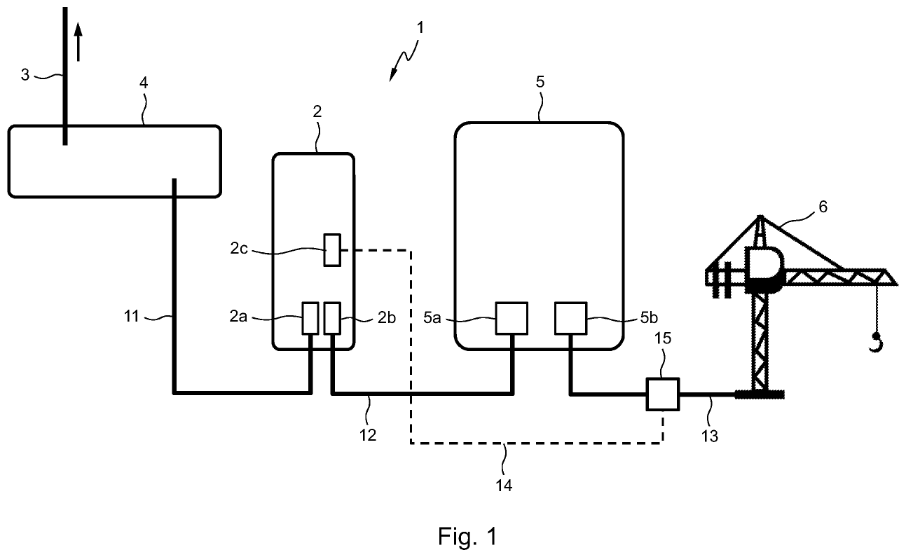

FIG. 1 shows a schematic view of a monitoring system 1 according to the invention, and

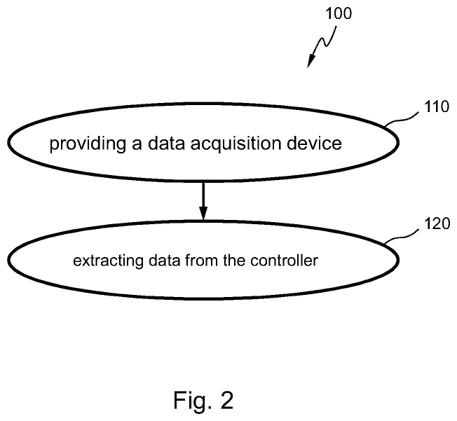

FIG. 2 shows a flow chart of an embodiment of a method according to the invention.

In the figures identical or corresponding parts are represented with the same reference numerals. The drawings are only schematic representations of embodiments of the invention, which are given by manner of non-limited examples.

FIG. 1 shows a schematic view of a monitoring system 1 according to the invention. The system 1 is used for monitoring and securing a network connected controller.

The system 1 includes a data acquisition device 2, also referred to as interplay device or gatekeeper, that is interconnected between a controller 5 to be monitored and/or protected and a network 3 to which the controller 5 is connected.

As described in more detail below, in a preferred embodiment, the data acquisition device 2 is arranged to perform interplay functionality including both data acquisition and process control, e.g. restoring data such as network data, software version, sensor data and/or actuator data in the controller, functioning as an interplay device.

In the shown embodiment, the data acquisition device 2 has a first terminal 2a and a second terminal 2b for connection with a respective first data line 11 and second data line 12. The data acquisition device 2 is connected to the network 3 via the first data line 11. Similarly, the data acquisition device 2 is connected to the controller 5 via the second data line 12. In the shown embodiment, the first data line 11 is connected to the network 3 via a network switch 4 enabling a protocol controlled data exchange, such as data packets, between the network 3 and the controller 5, via the acquisition device 2. Alternatively, the first data line 11 may be connected to the network 3 via another access point or connection terminal.

The network 3 can be implemented as an industrial ethernet protocol type network, such as PROFINET, Ethernet/IP and OPC. Generally, the network 3 may be public or private, and may have a local, interlocal or global coverage including LAN, CAN, MAN, WAN and GAN type networks. Further, the network 3 may be wired or at least partially be wireless.

The controller 5 can e.g. be implemented as a programmable logic controller PLC such as a traditional PLC having a separate processor, memory and I/O terminals housed in a casing, or a so-called slot PLC implemented on a card interfacing with a general purpose computer. Further, the controller 5 can e.g. be implemented as a so-called soft PLC mainly running as software in a general purpose computer or embedded system.

Generally, the controller 5 is arranged for controlling a controlled process in an actuator/sensor system. As an example, the controller 5 can be arranged to control a digital process in a customer service unit such as an automated teller machine ATM, a ticket delivery machine or security checkpoint equipment. As a further example, the controller 5 can be arranged to control a digital process in an infrastructural unit such as a facilitating unit in buildings including hospitals, shopping malls and other real estate, e.g. a climate system, or another infrastructural unit such as a digital controlled subsystem of a public, semi-public or private infrastructural asset e.g. in a maritime field, aviation field, traffic application or public or semi-public service facilities, such as an access control unit of bridge or sea lock, operational equipment of a maritime port or airport such as baggage handling machines, a water purification plant, an electric power plant etc. As yet another example, the controller 5 can be arranged to control a process in an industrial context such as a robot arm, an automated welding device or other machinery, a production equipment, conveyor belt or automated assembly line.

In the shown embodiment, the controller 5 has a first terminal 5a and a second terminal 5b for connection with the second data line 12 and a third data line 13. The second data line 12 interconnects the data acquisition device 2 with the controller 5, while the third data line 13 interconnects the controller 5 to an actuator and/or sensor system 6 such as a crane unit in a port area. The third data line 13 can be used for exchanging various types of data between the controller 5 and the actuator and/or sensor system 6, including command data, sensor data and other data such as identification data identifying the actuator and/or sensor system 6. The third data line 13 can be implemented e.g. as a fieldbus type network, such as PROFIBUS, CANBUS and MODBUS.

The data acquisition device 2 of the shown system 1 further includes a third terminal 2c for connection with a fourth data line 14 connected to an optional tap device 15 provided in the third data line 13. Then, data can be collected from the third data line 13. It is noted that the acquisition device 2 can be provided without the third terminal 2c, without the fourth data line 14 and/or without the optional tap device 15. In the shown embodiment, the data acquisition device 2 is arranged in series between the network 3 and the controller 5 realizing an inline monitoring structure, at the controller side of the network switch 4, thus obtaining a so-called man or machine in the middle on the wire.

According to an aspect of the invention, the data acquisition device 2 is arranged for extracting data from the controller 5. The extracted data can be used for a various number of processing purposes, including verification and controlling operation of the controller 5.

Here, the step of extracting data may be performed during operation of the controller 5, preferably at least during normal operation of the controller 5. In this process, the data acquisition device 2 does not impact operational data exchange between the controller 5 and the network 3, thereby minimizing interference with normal operational conditions of the controller 5.

Generally, the extracted data may include various types of data including network data, software data, a software program, sensor data and/or actuator data. The extracted data may be related to a digital process running on the controller 5, a digital process running on the actuator and/or sensor system 6 controlled by the controller 5 and/or to sensor data retrieved via sensors on the controller, on the actuator and/or sensor system 6 and/or in the proximity of the actuator and/or sensor system 6. It is noted that further data may be provided to the controller 5 and/or to the data acquisition device 5, e.g. via the network 3 and/or another data channel, e.g. weather forecast information.

The extracted data may be processed in various ways. As an example, the extracted data may be subjected to a decrypting, decompiling, comparing and/or verifying process. A decrypting process can typically be applied to encrypted data, e.g. software program running on the controller 5. Also, a decompiling process can be applied to program data, e.g. to retrieve which version of a program is running on the controller 5. Further, extracted data can be compared to approved data or other pre-specified and/or approved data that is expected to be used on a process running on the controller 5, e.g. at a block level. Here, any differences between the extracted data and pre-specified data, e.g. stored on the data acquisition device 2, can be detected, e.g. using a signature related detection technique, an artificial intelligence controlled anomaly detection algorithm and/or deep package inspection technology. The pre-specified data stored in a memory of the data acquisition device 2 can be static or may be updated over time. In a verifying process it can be verified or checked whether a correct version of software or a correct version of a parameter set of other data is used in a process running on the controller 5.

In case of uncertainty of the versions running on the controller 5, the acquisition device 2 can restore the latest known good configuration, thus meeting version integrity and certainty. All network connections trying to connect from the network 3 to the controller 5, and vice-versa, may continuously be monitored e.g. for changes, such as altering of addresses and/or new devices trying to connect with the controller 5. Preferably, any monitored change will be reported. Also, any monitored change may be blocked until an operator releases the change, e.g. a connection for safe operation.

The processing steps may at least partially be performed by the data acquisition device 2 itself, or by another device, e.g. by a server located remotely and receiving at least a portion of the extracted data, or data derived therefrom.

The data acquisition device 2 may further be arranged to perform a step of controlling a process running on the controller 5 and/or verifying and/or ensuring integrity of the controller configuration, based on the processing step. The step of controlling a process running on the controller 5 and/or verifying and/or ensuring a integrity of a controller configuration may include intervening the process, interrupting the process, initiating another process on the controller 5 and/or restoring data such as parameter data or a program version on the controller. As an example, a previous version of the software installed on the controller 5 or another software version may be re-installed, thereby counteracting un-authorized modifications of the software and complying with cyber security standards.

The data acquisition device 2, also referred to as interplay device, may thus perform both data acquisition and controlling steps, functioning as an interplay device.

Generally, measures can be taken to protect, acting as a virtual shield, the controller 5 and the actuator system 6 controlled by the controller, implementing a zero or near zero trust approach. Then, damage caused by malfunctioning of the controller 5, such as safety incidents, restriction of operational process, economic damage, non-compliance in view of cyber security requirements and/or operational requirements, can be counteracted and/or minimized.

Further, the data acquisition device 2 may be arranged to perform a step of transmitting an alert message, e.g. via the network 3 or another transmission channel, towards a server connected to a single or a multiple number of data acquisition devices, so as to keep the server informed about any status change of the controller 5 and/or abnormal or non-relevant data.

Further, the data acquisition device 2 may block such anomalies and/or may block identified malicious sender addresses or devices.

The initiation of controlling a process running on the controller 5 and/or verifying and/or ensuring controller configuration integrity may be performed autonomously by the data acquisition device 2 or may be performed at least partially via a server having received the alert message.

The monitoring system 1 has the advantageous features of reliability and real time performance. The device 2 serves as a by-pass network element and an intelligent bridge monitoring and controlling a process running on the controller 5. The system 1 can advantageously be used to monitor operational processes in highly critical infrastructural assets such as public service facilities and airport subsystems.

FIG. 2 shows a flow chart of an embodiment of a method 100 according to the invention. The method 100 is used for monitoring and securing a network connected controller. The method comprises a step of providing 110 a data acquisition device interconnected between the controller and the network, and a step of extracting 120 data from the controller, using the data acquisition device

The method for monitoring and securing a network connected controller can also at least partially be performed using a computer program product comprising instructions for causing a processor of the data acquisition device to perform at least one step of the method according to the invention, e.g. at least the step of extracting 120 data from the controller. All (sub)steps can in principle be performed on a single processor. However, it is noted that at least one (sub)step can be performed on a separate processor. A processor can be loaded with a specific software module.

Dedicated software modules can be provided, e.g. from the Internet.

The invention is not restricted to the embodiments described herein. It will be understood that many variants are possible.

It is noted that the data lines 11, 12, 13 interconnecting the network 3, the data acquisition device 2 and the controller 5 can be wired or at least partially wireless, respectively. Further, data packets transmitted via the data lines can at least partially be encrypted.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A method for monitoring and securing a network connected controller, comprising the steps of:
providing a data acquisition device interconnected between the controller and a network, and
extracting data from the controller, using the data acquisition device.

2. The method according to claim 1, wherein the data is extracted during operation of the controller.

3. The method according to claim 1, wherein the data acquisition device enables operational data exchange between the controller and the network.

4. The method according to claim 1, further comprising processing the extracted data.

5. The method according to claim 4, wherein the processing the extracted data comprises at least one of decrypting the extracted data, decompiling the extracted data, or comparing the extracted data with pre-specified data.

6. The method according to claim 4, further comprising, based on the processing step at least one of:
controlling a process running on the controller;
verifying an integrity of a controller configuration;
ensuring the integrity of the controller configuration; or
transmitting an alert message.

7. The method according to claim 6, wherein at least one of controlling the process running on the controller, verifying the integrity of the controller configuration, or ensuring the integrity of the controller configuration comprises intervening in a process, interrupting the process, initiating another process on the controller, or restoring data on the controller.

8. The method according to claim 1, wherein the data acquisition device is interconnected between the controller and a network switch.

9. The method according to claim 1, wherein the extracted data comprises at least one of network data, software data, a software program, sensor data, or actuator data.

10. The method according to claim 1, wherein the controller is arranged for controlling a controlled process in at least one of an actuator or a sensor system.

11. The method according to claim 1, wherein the network is an industrial ethernet protocol type network.

12. The method according to claim 1, wherein the controller is a PLC or an embedded system.

13. The method according to claim 6, wherein at least one of extracting data from the controller process, controlling a process running on the controller verifying integrity of the controller configuration, or ensuring the integrity of the controller configuration can be at least one of non-intrusive, independent on technology, independent on protocol, or independent on a supplier of at least one of the network or the controller.

14. A monitoring system for monitoring and securing a network connected controller, wherein the system comprises a data acquisition device interconnectable between the controller and a network, wherein the data acquisition device is arranged for extracting data from the controller.

15. A non-transitory computer-readable computer program product for monitoring and securing a network connected controller, the computer program product comprising computer-readable code for causing a data acquisition device interconnected between the controller and a network to perform the step of extracting data from the controller.
